(19) United States
(12) Patent Application Publication
(10) Pub. No.: US 2009/0157289 A1
(43) Pub. Date: Jun. 18, 2009

(54) Navigation Systems and Services

(75) Inventor: Joshua V. Graessley, Sunnyvale, CA (US)

Correspondence Address: FISH & RICHARDSON P.C., PO BOX 1022, MINNEAPOLIS, MN, 55440-1022, US

(73) Assignee: Apple Inc., Cupertino, CA (US)

(21) Appl. No.: 11/959,084

(22) Filed: Dec. 18, 2007

(51) Int. Cl. G01C 21/34

(52) U.S. Cl. 701/123; 701/209; 701/118; 701/30; 340/995.19; 235/375

(57) ABSTRACT

Navigation systems and services are described. The navigation services can include obtaining a route or route segment based on a location of a vehicle and a destination. Based on the route, a current fuel supply of the vehicle, and a number of factors related to fuel consumption, a refueling location can be estimated. A number of locations of fuel stations in proximity to the refueling location can be determined and presented to a user, for example, on a map showing the route.

### TECHNICAL FIELD

The subject matter of this application generally relates to navigation systems and services.

### BACKGROUND

Navigation systems are becoming increasingly popular equipment of modern day vehicles (e.g., cars, motorcycles, boats). Typically, navigation systems use GPS (global positioning system) technology to determine the vehicle's current position. A route from the current position to a destination can be shown superimposed on a map on a navigation display. Audio directions can also be provided, so the driver is not distracted by trying to view the map while driving. Some navigation systems are Internet-connected and can automatically and wirelessly update their software and features. Some vehicles integrate music systems and navigation systems into a single media console. Conventional navigation systems often display additional information (e.g., labels, pushpins, icons, text), which can clutter the display and confuse the driver. A cluttered screen can be dangerous in that it requires the driver to focus on the display rather than the road.

Many modern vehicles include onboard computers that generate information describing the operational state of the vehicle. Conventional navigation systems, however, do not have access to such information, and, therefore, cannot use the information to generate navigation-related information that may benefit the driver.

### SUMMARY

This invention relates to a navigation systems and services. In general, in one aspect, the invention features a method, computer-readable medium including instructions to cause a processor to perform operations and a system for providing navigation services. The navigation services include obtaining a route or route segment based on a location of a vehicle and a destination. Based on the route, a current fuel supply of the vehicle, and a number of factors related to fuel consumption, a refueling location is estimated. A number of locations of fuel stations in proximity to the refueling location are determined and are presented to a user.

Implementations of the invention can include one or more of the following features. The locations of the fuel stations can be presented to the user on a map including a display of the route. Traffic information relating to current traffic conditions affecting the route can be received. Estimating the refueling location can include determining additional fuel requirements due to traffic affecting the route. The fuel stations presented can be filtered according to a predefined criteria. For example, the predefined criteria can include user-defined criteria selecting one or more fuel providers.

Based on the route, a current time of day and a fuel efficiency of the vehicle, an approximate time of day the vehicle will reach the refueling location can be determined. If the time of the day is within a defined proximity to a meal-time, then the locations of one or more restaurants can be presented that are within a defined distance to the one or more fuel stations. In some implementations, if the time of day is within a defined proximity to a meal-time, but there are less than a threshold number of restaurants within a defined distance to the refueling location, then the refueling location can be adjusted to be closer to the current location of the vehicle. The locations of one or more restaurants and fuel stations within a defined distance to the adjusted refueling location can be presented.

In some implementations, if the time of day is within a defined proximity to a meal-time but there are no restaurants satisfying a user-defined criteria located within a defined distance to the refueling location, then the refueling location can be adjusted to be closer to the current location of the vehicle. Locations of one or more restaurants satisfying the user-defined criteria and fuel stations within a defined distance to the adjusted refueling location can be presented.

Estimating a refueling location can further include, based on the route and a fuel efficiency of the vehicle, determining when the fuel amount will be less than a user-defined threshold amount.

In implementations where the factors related to fuel consumption include a fuel efficiency of the vehicle, the fuel efficiency can be received from a vehicle computing system included in the vehicle. In other implementations, the fuel efficiency can be calculated based on fuel amounts and odometer readings received from a vehicle computing system included in the vehicle.

In general, in another aspect, the invention features a method, computer-readable medium including instructions to cause a processor to perform operations and a system for providing navigation services, where the navigation services include receiving at a navigation system, present in a vehicle, information from a vehicle computing system present in the vehicle. The information relates to the vehicle requiring servicing. A current location of the vehicle is determined. Locations of one or more vehicle repair stations in a predefined proximity to the current location of the vehicle are obtained. The current location of the vehicle and the locations of the one or more vehicle repair stations are presented to a user.

Implementations of the invention can include one or more of the following features. A display of the map including indications of the current location of the vehicle and the locations of the one or more vehicle repair stations can be presented to the user. A user-input setting can be received to filter the vehicle repair stations indicated on the map based on a user-defined criteria.

In general, in another aspect, the invention features a method, computer-readable medium including instructions to cause a processor to perform operations and a system for providing navigation services, where the navigation services include obtaining a route or route segment based on a location of a vehicle and a destination and receiving a user request for locations of restaurants. Based on a current location of the vehicle and the route being traveled, a number of locations of restaurants that are in proximity to the current location and along the route can be determined. The number of locations of restaurants can be presented to a user.

In one implementation, presenting the number of locations of restaurants includes presenting a graphical representation of the locations on a map showing the route.

In general, in another aspect, the invention features a navigation system present in a vehicle for providing fuel-related navigation services. The navigation system includes a positioning system, a map application, a routing application, a fuel module and a presentation engine. The positioning system is configured to determine a current location of the vehicle. The map application is configured to provide a map including the current location and a user-defined destination. The routing application is configured to provide a route from the current location to the destination. The fuel module is configured to determine whether a current fuel amount in the vehicle is sufficient for the vehicle to travel the route, and if not, to determine a refueling location. The fuel module is further configured to obtain locations for one or more fuel stations within a defined proximity to the refueling location. The presentation engine is configured to provide a display of the map including the route and locations of the one or more fuel stations indicated thereon.

Implementations of the invention can realize one or more of the following advantages. The driver of a vehicle can be provided real-time information related to the operational state of the vehicle (e.g., the level of fuel in the vehicle). In some implementations, the driver is automatically provided advance warning of a refueling location and information about where the vehicle can conveniently be refueled. In other implementations, the driver is provided notification of a vehicle maintenance issue and given immediate information about conveniently located vehicle repair stations. These features can reduce driver distraction, reduce the risk of the vehicle running out of fuel and thereby improve road safety for the driver.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIGS. 1A-1C are block diagrams of example systems to provide fuel-related navigation services.

FIG. 2 is a flow chart showing an example process to provide a fuel-related navigation service.

FIG. 3 is a block diagram of an example navigation system to provide fuel-related navigation services.

FIG. 4 is an example graphical user interface showing a map including a route and fuel station information.

FIG. 5 is a block diagram of an example navigation system architecture.

FIG. 6 is a block diagram of an example network operating environment for a navigation system.

Like reference symbols in the various drawings indicate like elements.

### DETAILED DESCRIPTION

Techniques, apparatus and systems for providing a fuel-related navigation service are described.

### Fuel-Related Navigation Service Overview

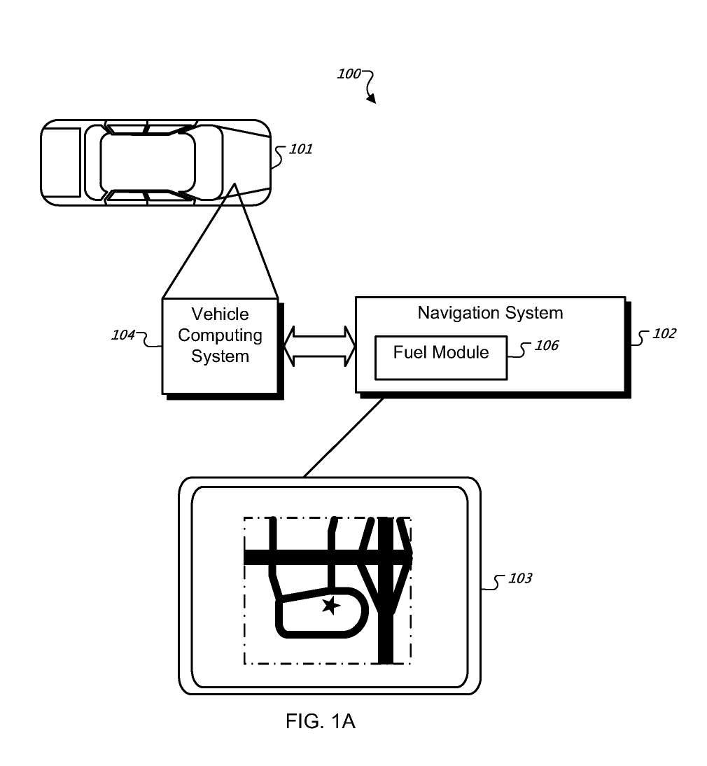

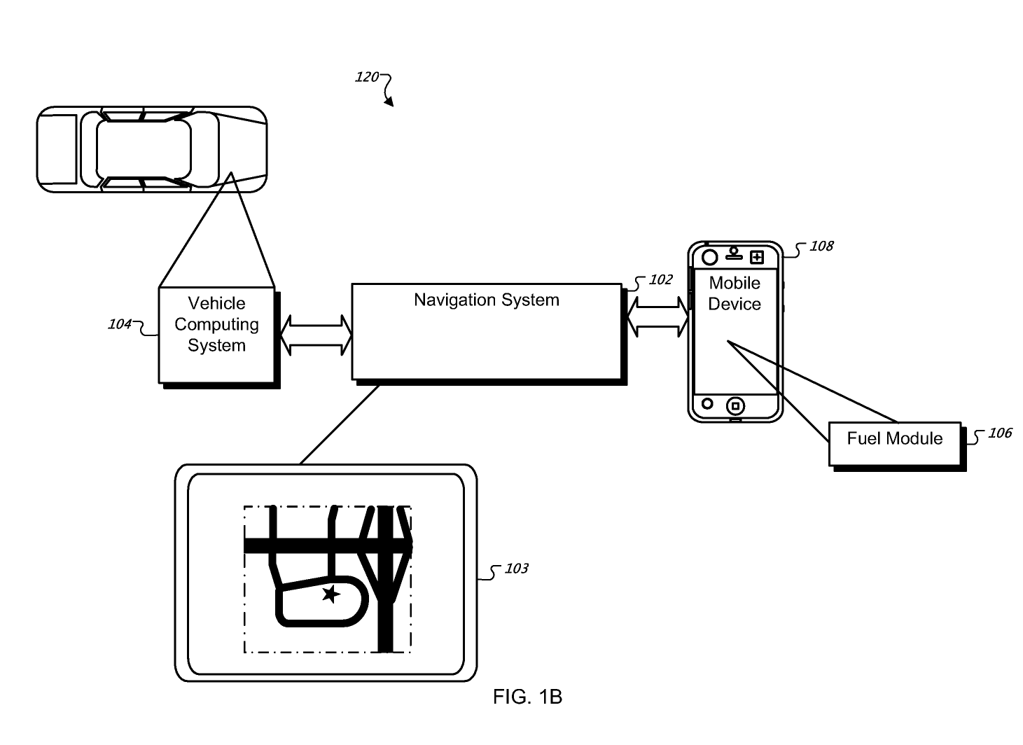

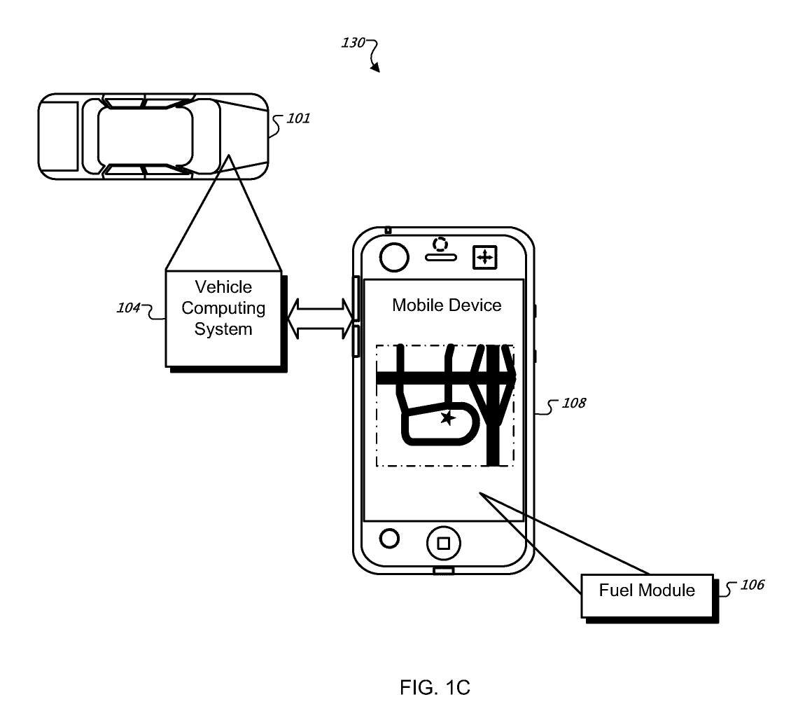

Referring to FIG. 1A, an example system 100 is shown for providing a fuel-related navigation service. The system 100 includes a navigation system 102 in communication with a vehicle computing system 104. The vehicle computing system 104 can be a conventional computer (including software, firmware and/or hardware) present within a fuel-driven vehicle. The navigation system 102 includes a fuel module 106. The fuel module 106 is configured to combine fuel information about the vehicle with a route mapped by the navigation system 102 to provide meaningful fuel-related information to a driver of the vehicle. As used herein, the term “fuel” includes a variety of energy sources (e.g., fossil fuels, biofuels, electricity, hybrid power). Also, the term “vehicle” includes any vehicle that could benefit by using a navigation system, including automobiles, buses, motorcycles, boats, etc.

Referring to FIG. 1B, in other implementations, the fuel module 106 is external to the navigation system. That is, a navigation system 102 is included in the fuel-driven vehicle and is in communication with the vehicle computing system 104. The fuel module 106 is in communication with the navigation system 102 and the vehicle computing system 104 (either directly or through the navigation system 102). In one implementation, the fuel module 106 is included within a mobile device (e.g., mobile device 108).

Referring to FIG. 1C, in other implementations, a mobile device 108 configured to provide navigation services and including the fuel module 106 can be used with the fuel-driven vehicle, and is in communication with the vehicle computing system 104. In some implementations, the mobile device can be tethered or docked to the navigation system 102 and/or vehicle computing system 104. In other implementations, the mobile device can be in wireless communication with the navigation system 102 and/or vehicle computing system 104. The navigation system 102 and the vehicle computing system 104 can communicate using wired or wireless communication channels. In some implementations, the navigation system 102 and vehicle computing system 104 can be a single, integrated device. In other implementations, the fuel module 106 can be included within the vehicle computing system 104 itself.

For illustrative purposes, the description below describes the fuel module 106 as included in the navigation system, i.e., the system shown in FIG. 1A. However, it should be understood that the description applies to other implementations, including those where the fuel module 106 is included in a mobile device or within the vehicle computing system 104 itself.

The fuel module 106 is configured to receive fuel information from the vehicle, for example, from the vehicle computing system 104. The fuel information can include a current fuel amount present in the vehicle. The fuel module 106 is further configured to determine a fuel efficiency (e.g., miles per gallon for city and highway driving) for the vehicle. In one example, the fuel module 106 determines the fuel efficiency by receiving either an actual or estimated fuel efficiency for the vehicle from the vehicle computing system 104, i.e., as part of the fuel information. In another example, the fuel module 106 queries an external source of information for an estimated fuel efficiency of the vehicle, e.g., based on the vehicle's make, model and production year. The query can be made over a network, for example, the Internet.

In another example, the fuel module 106 is configured to calculate the fuel efficiency of the vehicle. For example, the fuel module 106 can receive a first fuel level and first odometer reading from the vehicle computing system 104 at a first time and then a second fuel level and second odometer reading at a later time. The fuel module 106 can thereby calculate the fuel used to travel the distance between the two odometer readings and thereby calculate a fuel efficiency for the vehicle. That is, the fuel module 106 can compute a difference between the first and second odometer readings and divide the difference by the fuel consumed between odometer readings. In some implementations, the driver can enter fuel efficiency information in the navigation system manually or automatically through a network connection for web-enabled navigation systems.

In some implementations, the fuel module 106 can take other factors into consideration in determining the fuel efficiency. For example, the fuel module 106 can use location-based services to determine current weather conditions, current traffic flow, or other relevant driving conditions, which factors can contribute to a reduced or improved fuel efficiency. By way of example, if the ambient temperature is within a certain defined range indicating either extremely cold or hot weather, the fuel module 106 can reduce the determined fuel efficiency by a defined percentage to account for additional fuel consumed in cold weather due to heating requirements and hot weather due to cooling requirements. In another example, if the current traffic flow indicates stop and go traffic, the fuel module 106 can reduce the determined fuel efficiency by a defined percentage to account for additional fuel consumed while idling in stalled traffic. Other techniques can be used to adjust the fuel efficiency based on current conditions and the examples provided are merely illustrative.

In some implementations, the fuel module 106 uses the fuel efficiency of the vehicle to determine if the fuel in the vehicle is insufficient for the vehicle to travel a route or route segment. If the fuel module 106 determines that the available fuel is insufficient to travel a route or route segment, then the fuel module 106 determines a location along the route where re-fueling will become necessary, i.e., a refueling location. The fuel module 106 can be further configured to determine one or more fuel station locations in the vicinity of the refueling location along the route, and notify the driver of the need to re-fuel and the location of the one or more fuel stations.

The navigation system 102 can be configured to highlight the refueling location superimposed on the map to notify the driver of the location by which to refuel. If fuel station map data is not locally available (e.g., on a DVD), the navigation system 102 and/or the fuel module 106 can be configured to send a query to a location based service for locations of one or more fuel stations within a defined proximity to the refueling location (e.g., within a 5-mile radius). Upon receiving a response to the query with the fuel station locations, the locations can be presented to the vehicle's driver. For example, the navigation system 102 can superimpose graphical indications of the fuel stations on the displayed map showing the route.

### Example Fuel-Related Navigation Service Process

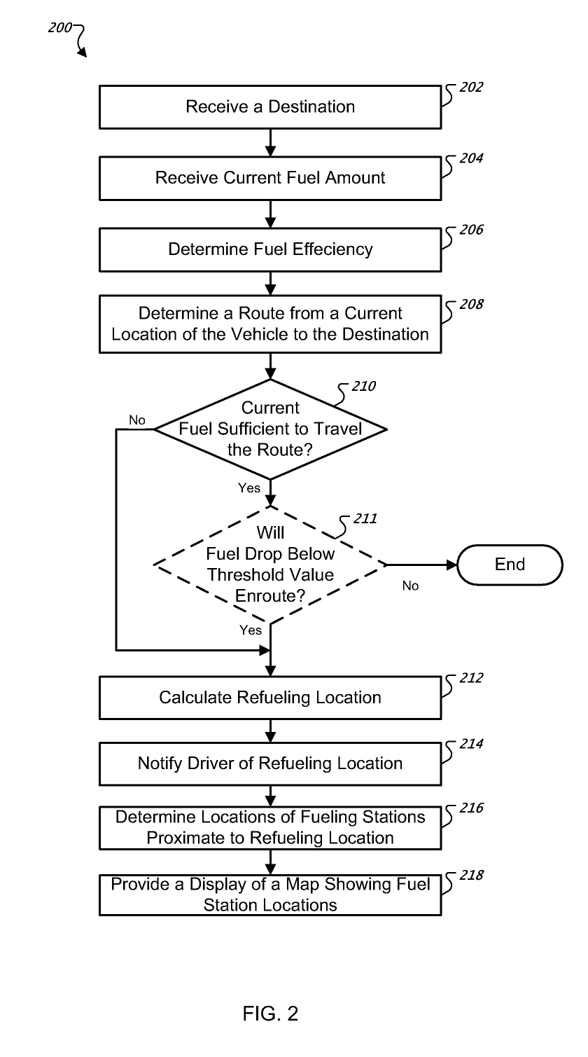

Referring to FIG. 2, an example process 200 for providing a fuel-related navigation service is shown. A destination is received at a navigation system present in a fuel-driven vehicle (Step 202). For example, in one implementation a driver of the vehicle inputs a target destination for the vehicle by way of a user interface provided by the navigation system, e.g., a touch screen, keyboard, pointing device and/or microphone.

A current fuel amount is received at a fuel module (Step 204). For example, by way of illustration, referring to FIG. 1A, the vehicle computing system 104 can provide the current fuel amount present in the vehicle to the fuel module 106. A fuel efficiency of the vehicle is determined (Step 206). For example, the vehicle computing system 104 can provide an actual or estimated fuel efficiency of the vehicle to the fuel module 106. In other examples, as discussed above, the fuel module 106 can calculate the fuel efficiency based on fuel information received from the vehicle computing system 104 or from the user, or can otherwise determine an estimated fuel efficiency, for example, by querying an external source of information.

A route is determined from a current location of the vehicle to the destination (Step 208). For example, the navigation system can either determine or otherwise receive information providing the current location of the vehicle. A route is then determined for the vehicle to travel to the destination.

Based on the route distance (e.g., miles) and the fuel efficiency (e.g., estimated miles/per gallon), whether or not the current fuel amount is sufficient for the vehicle to travel the route or a route segment is determined (Step 210). If the current fuel amount is insufficient, a refueling location is determined (Step 212). A refueling location can be a location along the route at which point the vehicle will require refueling (but before the vehicle becomes inoperable due to lack of fuel).

Optionally, in one implementation, whether the fuel amount in the vehicle will drop below a threshold value while enroute to the destination can be determined (Step 211). The threshold value is a user-input value threshold fuel tank level corresponding to a minimum fuel level the user deems acceptable to operate the vehicle. For example, in cold temperatures, it is advised not to go below one-half tank of gas to avoid condensation in the fuel tank. Accordingly, during winter months the user may set the filter setting to notify the user when the fuel tank is in danger of falling below a threshold level of a one-half tank. In such an example, although the current fuel may be sufficient to travel the route (i.e., “yes” branch of decision step 210), the fuel amount may be determined to fall below the threshold value before reaching the destination (i.e., “yes” branch of decision step 211). If so, then a refueling location is calculated (step 212).

The refueling location is provided to the driver of the vehicle (Step 214). For example, the refueling location can be shown highlighted (e.g., with pushpins or icons) on a map displaying the route and/or the driver can be notified by an audio or textual message.

The locations of fuel stations within a defined proximity to the refueling location are determined (Step 216) and presented to the driver (Step 218). For example, in one implementation, the navigation system 102 includes, or communicates with, location-based services that can provide locations of businesses of a particular type within a defined radius surrounding a refueling location. The business type can be set to fuel station and the location can be the refueling location. The locations of the fuel stations can then be graphically displayed on the map.

In some implementations, the driver can select a graphical representation of a fuel station (e.g., a pushpin, icon), for example, by using a touch screen to touch the graphical representation, to learn additional information about the particular fuel station. For example, the additional information can include the name of the fuel station, type of fuel available, other services available at the fuel station (e.g., restaurant, convenience store, etc.) and other such information.

### Example Navigation System and Fuel Module

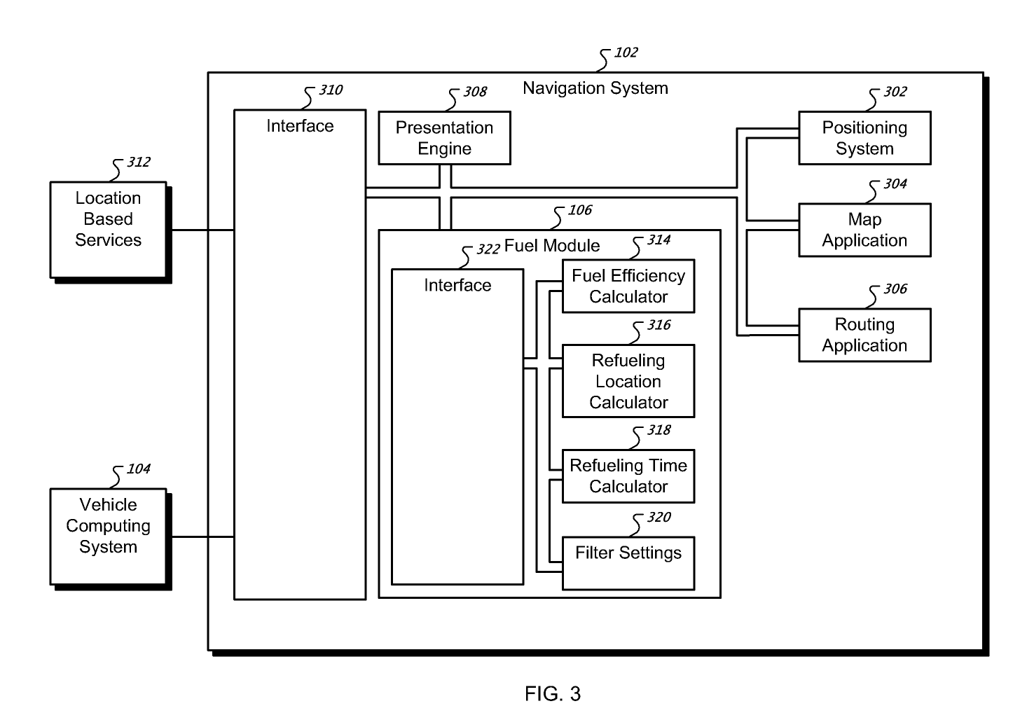

Referring to FIG. 3, a block diagram shows an example navigation system and fuel module that can be used to implement the navigation system and fuel module shown in FIGS. 1A-C. However, it should be understood that other configurations of navigation system and fuel module can be used, and the configurations shown are for illustrative purposes.

The navigation system 102 in this example includes a positioning system 302, map application 304, routing application 306, presentation engine 308, fuel module 106 and interface 310, as are described in further detail below. In some implementations, one, some or all of the components of the navigation system 102 can be implemented in other devices or systems (e.g., a vehicle computing system, mobile device, network server).

The positioning system 302 can be provided by the navigation system 102 to determine the current location of the vehicle. In some implementations, the positioning system 302 can employ positioning technology including a GPS, a cellular grid, television signals, Wi-Fi base stations, URIs or any other technology for determining the geographic location of the vehicle. In such implementations, the user can occasionally reset the positioning system 302 by marking the vehicle's presence at a known location (e.g., a landmark or intersection). In other implementations, the positioning system 302 can be provided by using wireless signal strength and one or more locations of known wireless signal sources to provide the current location. Wireless signal sources can include access points and/or cellular towers. In still other implementations, the user can enter a set of position coordinates (e.g., latitude, longitude) corresponding to the vehicle's location. Other techniques to determine a current location of the vehicle can be used and other configurations of the positioning system are possible.

The map application 304 can be provided either internally (e.g., from a local database or medium in the vehicle) or by way of interfacing with an external map service available through a network connection. By way of example, the map application can be Google® Maps API provided by Google, Inc. of Mountain View, Calif., although other map applications can be used. In response to a request for a map that includes the current location of the vehicle and the destination location sent to the map application 304, a map can be received and displayed on the user interface display 103.

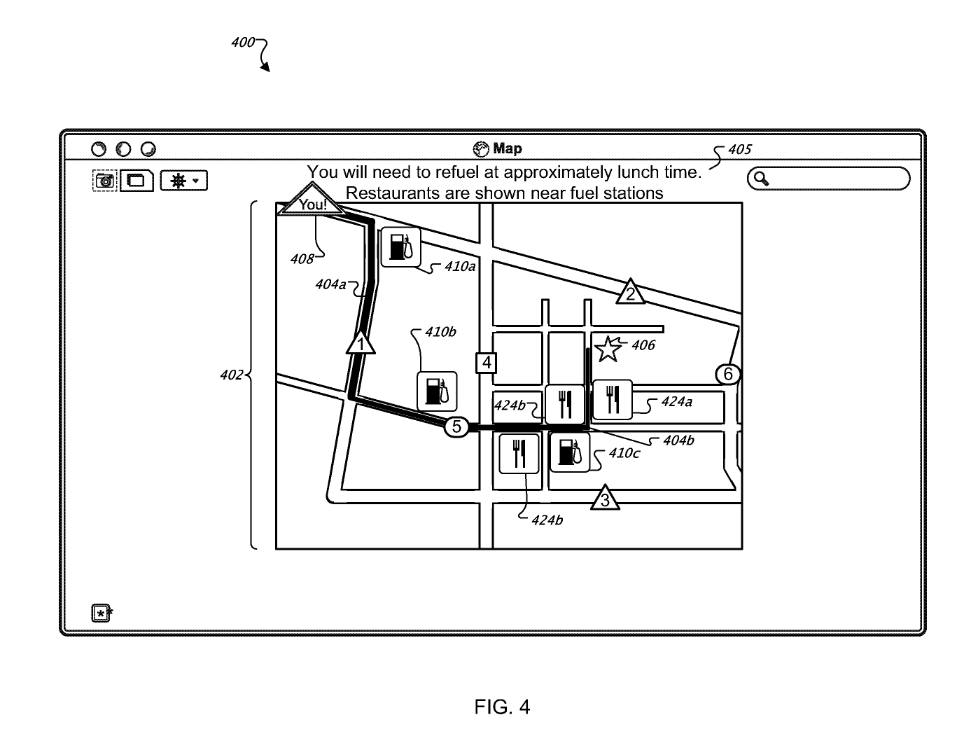

Referring to FIG. 4, an example map 402 that can be displayed in the user interface display 103 is shown. In this illustrative example, the map 402 displays a route 404 that has been determined by the navigation system 102 between a current location of the vehicle and a destination location 406 entered by a user of the navigation system 102. The route 404 from the current location to the destination 406 can be determined using the routing application 306 provided internally or by way of interfacing with an external routing service. By way of illustration, Google Maps API is one example of existing routing technology.

The presentation engine 308 can be provided to receive the map from the map application 304 and the route from the routing application 306. The presentation engine 308 can overlay the route on the map to generate the map display shown in FIG. 4. Additionally, the presentation engine 308 can receive the locations of the one or more fuel stations from the location-based service or database include in the navigation system, and overlap a graphical representation of the fuel stations on the map display as shown by elements 410a-c.

The interface 310 can be used to communicate with the vehicle computing system 104. Additionally, if location based services are required, for example, to obtain the locations of fuel stations, the interface 310 can be used to communicate with one or more location based services represented by element 312. The interface can be used to receive user input, such as a destination and one or more filter settings. The interface 310 can include any convenient means for communicating with the driver, including a touch screen, keyboard, audio receiver/transmitter, and the like.

Referring now to the fuel module 106, in this example, the fuel module 106 includes an interface 322, a fuel efficiency calculator 314, a refueling location calculator 316, a refueling time calculator 318 and filter settings 320. The fuel efficiency calculator 314 can be used to calculate the fuel efficiency of the vehicle 101, for example, using techniques described above. The refueling location calculator 316 is configured to determine the refueling location, as was previously described.

The filter settings 320 can be configured to received various settings, including default settings and user input settings. In some implementations, the filter settings 320 include a setting configured to filter the fuel stations displayed on the map. For example, the user can input a filter setting to filter the fuel stations by business (e.g., Sinclair, Holiday Stationstores, BP, and the like), by type of fuel (e.g., diesel, E85, and the like), business hours, whether the fuel station includes a convenience store, or other criteria. In general, the filtering can be accomplished by communicating with one or more location based services or map database, and accessing information regarding the fuel stations. For example, a search string corresponding to the filtering criteria can be provided to the Google Maps API which can provide locations of fuel stations corresponding to fuel stations that match the search string.

In one implementation, a user can specify as a filter setting estimated fuel mileage for different route segments. That is, for example, the user can specify an estimated fuel mileage for highway route segments and a different (likely lower) estimated fuel mileage for city route segments. The example route 404 shown in FIG. 4 includes a highway route segment 404a and a city route segment 404b. The filter setting can be used by the fuel module 106 to calculate the amount of fuel consumed for the two route segments based on the two different estimated file mileage settings.

In some implementations, the fuel module 106 can include the refueling time calculator 318. The refueling time calculator 318 is configured to determine an approximate time of day when the vehicle 101 will reach the refueling location. For example, the fuel module 106 can receive posted speed limits from a location based service, or from the mapping database, and calculate approximately how long the vehicle will take to travel from the current location to the refueling location when traveling at the posted speed limits. In some implementations, current traffic conditions can be obtained from a location based service and used in calculating the time to travel. For example, if the current traffic conditions indicate that the traffic is currently flowing at a speed that is 50% of the posted speed limit, then the time to travel can be calculated based on the actual speed of traffic. In other implementations, the user can specify speed targets for one or more segments of a route by entering the targets using the navigation system interface.

Based on the length of time to travel calculated and the current time, in some implementations the fuel module 106 can determine whether the vehicle will reach a refueling location at approximately a meal time. For example, if the refueling location will be reached between 6:00-9:00 am that can be the “breakfast time”, between 11:00 am-2:00 pm can be the “lunch time” and between 5:00-8:00 pm can be the “dinner time”. If the refueling location will be reached during either the breakfast time, lunch time or the dinner time, then the fuel module 106 can also determine locations of eating establishments at or nearby fuel stations.

For example, as illustrated by FIG. 4, eating establishments 424a-424c are additionally displayed because of their proximity to fuel stations 410a and 410b. As illustrated by FIG. 4B, the navigation system 102 can display an appropriate message to the user, for example, message 422. In some implementations, the eating establishments can also be filtered by receiving filtering criteria from the user. For example, eating establishments can be filtered based on type of cuisine, average price, customer reviews, or other criteria.

In one implementation, if the refueling location is estimated to be reached by the vehicle during a meal time and upon determining the locations of eating establishments near the refueling location it is determined that there are none (or less than a threshold amount) within a predefined proximity to the refueling location, then the refueling location can be adjusted to be closer to the current location of the vehicle. A new determination can be made of locations of fuel stations and eating establishments near the adjusted refueling location, and the locations presented to the driver of the vehicle. However, if the adjusted refueling location again is not within a defined proximity to a restaurant (or threshold number thereof), the refueling location can again be re-adjusted. Similarly, if the user has input a filter setting for a particular type or chain of restaurant, and none are within proximity to the initial refueling location, the refueling location can be adjusted as described.

By way of example, if the route includes a highway segment that includes few if any restaurants, the refueling location may be outside of a predefined proximity, e.g., 5 miles, to a restaurant. To avoid the driver having to stop once for a meal and then a second time to refuel, the refueling location can be adjusted, e.g., to be 7 miles closer to the current location of the vehicle. The fuel module 106 can then determine locations of fuel stations and restaurants near the adjusted refueling location and present the locations to the driver. The driver can then select where to stop to refuel and have a meal.

In another implementation, the navigation system 102 can include a feature whereby a driver of the vehicle can request locations of restaurants located in the direction of the current route. That is, the restaurant locations present to the driver will include restaurants on the route that are within a defined proximity to the current location of the vehicle, but have not yet been driven past and are close to the route. That is, not only is the current location of the vehicle taken into account when determining locations of restaurants to present to the driver, but the current route being traveled is considered. Accordingly, restaurants conveniently located enroute can be presented, rather than just within an arbitrary radius to the current location. In one implementation, the driver can activate the feature by touching a button, or the like, on a user interface, e.g., a touch screen. In other implementations, the feature can be activated by an audio command. Other configurations can be used to activate the feature, and the ones mentioned are merely illustrative.

In another implementation, the filter settings 320 can include a setting whereby a user can input a threshold fuel tank level corresponding to a minimum fuel level the user deems acceptable to operate the vehicle, as was discussed above.

### Example Navigation System Architecture

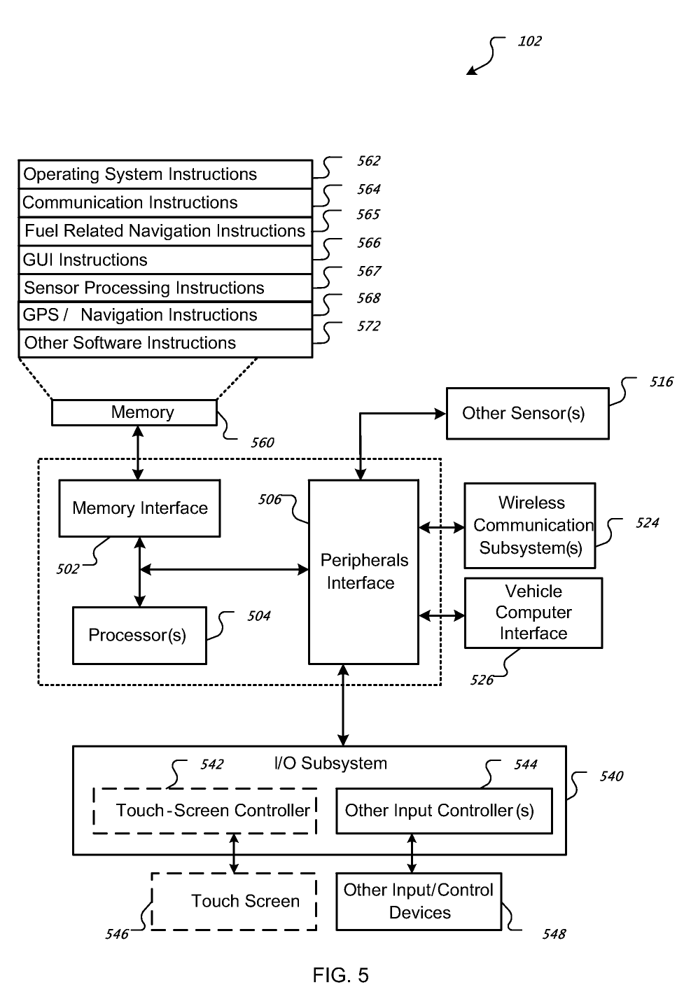

Referring now to FIG. 5, a block diagram is shown of an example navigation system 102 that can be used to implement the navigation system 102 described above. In this example, the navigation system 102 can include wireless communication capabilities, for example, to communicate with a location based service.

The navigation system 102 can include a memory interface 502 one or more data processors 504 (e.g., image processors and/or central processing units) and a peripherals interface 506. The memory interface 502, the one or more processors 504 and/or the peripherals interface 506 can be separate components or can be integrated in one or more integrated circuits. The various components in the navigation system 102 can be coupled by one or more communication buses or signal lines. For example, other sensors 516 can be connected to the peripherals interface 506, such as a positioning system (e.g., a GPS receiver), a temperature sensor, a biometric sensor, or other sensing device, to facilitate related functionalities. The peripherals interface 506 can be used to interface with a vehicle computer interface 626 of a vehicle computing system, e.g., the vehicle computing system 104 shown in FIGS. 1A-C.

Communication functions can be facilitated through one or more wireless communication subsystems 524, which can include radio frequency receivers and transmitters and/or optical (e.g., infrared) receivers and transmitters. The specific design and implementation of the communication subsystem 524 can depend on the communication network(s) over which the navigation system 102 is intended to operate. For example, the navigation system 102 can include communication subsystems 524 designed to operate over a GSM network, a GPRS network, an EDGE network, a Wi-Fi or WiMax network, and a Bluetooth™ network.

In this example, the I/O subsystem 540 include an optional touch screen controller 542 and/or other input controller(s) 544. The touch-screen controller 542 can be coupled to an optional touch screen 546. The touch screen 546 and touch screen controller 542 can, for example, detect contact and movement or break thereof using any of multiple touch sensitivity technologies, including but not limited to capacitive, resistive, infrared, and surface acoustic wave technologies, as well as other proximity sensor arrays or other elements for determining one or more points of contact with the touch screen 546.

The other input controller(s) 544 can be coupled to other input/control devices 548, such as one or more buttons, rocker switches, thumb-wheel, infrared port, USB port, and/or a pointer device such as a stylus. The one or more buttons (not shown) can include an up/down button for volume control of the speaker 528 and/or the microphone 530. The touch screen 546 can, for example, also be used to implement virtual or soft buttons and/or a keyboard. Other input/output and control devices can also be used.

The memory interface 502 can be coupled to memory 560. The memory 560 can include high-speed random access memory and/or non-volatile memory, such as one or more magnetic disk storage devices, one or more optical storage devices, and/or flash memory (e.g., NAND, NOR). The memory 560 can store an operating system 662, such as Darwin, RTXC, LINUX, UNIX, OS X, WINDOWS, or an embedded operating system such as VxWorks. The operating system 562 may include instructions for handling basic system services and for performing hardware dependent tasks. In some implementations, the operating system 562 can be a kernel (e.g., UNIX kernel).

The memory 560 may also store communication instructions 564 to facilitate communicating with one or more additional devices, one or more computers and/or one or more servers. The memory 560 includes fuel-related navigation instructions 565 to facilitate fuel module processing. The memory 560 can include GPS/Navigation instructions 568 to facilitate GPS and navigation-related processes and instructions. The memory 560 can include graphical user interface instructions 566 to facilitate graphic user interface processing and sensor processing instructions 567 to facilitate sensor-related processing and functions (if any).

Each of the above identified instructions and applications can correspond to a set of instructions for performing one or more functions described above. These instructions need not be implemented as separate software programs, procedures or modules. The memory 560 can include additional instructions or fewer instructions. Furthermore, various functions of the navigation system 102 can be implemented in hardware and/or in software, including in one or more signal processing and/or application specific integrated circuits.

### Example Network Operating Environment

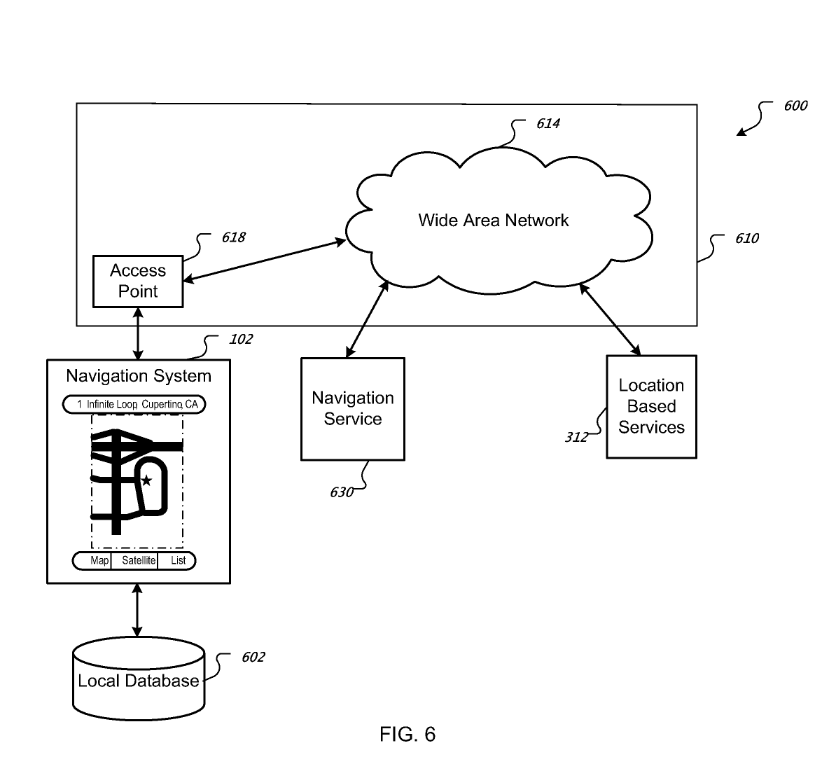

FIG. 6 is a block diagram of an example network operating environment 600 for the navigation system 102. In some implementations, the navigation system 102 can, for example, communicate over one or more wired and/or wireless networks 610 in data communication. For example, an access point 618, such as an 802.11g wireless access point, can provide communication access to a wide area network 614. In some implementations, the navigation system 102 can be physically connected to the access point 618 using one or more cables and the access point 618 can be a computer. In this configuration, the navigation system 102 can be referred to as a “tethered” device.

The navigation system 102 can communicate with one or more services 630, 312 over the one or more wired and/or wireless networks 610. For example, a navigation service 630 can provide navigation information, e.g., map information, location information, route information, and other information, to the navigation system 102. In other implementations, the navigation system 102 obtains map, location and route information from a local database 602. In other implementations, the navigation system 102 uses a combination of the local database 602 and location based services 312.

### Other Implementations

Referring again to FIGS. 1A-C, in other implementations, additional vehicle operating-condition information can be provided from the vehicle computing system 102 to the fuel module 106. For example, if the vehicle computing system diagnoses a failure or imminent failure with respect to the vehicle, for example, of the nature that would trigger a warning to be presented to the driver on the dashboard, information of this vehicle operating condition can be transmitted to the fuel module 106. The fuel module 106 can then determine the location of one or more vehicle repair stations in the immediate vicinity. For example, the fuel module 106 can send a request to a location-based service for businesses satisfying particular criteria, in this instance, vehicle repair stations in a defined proximity to a current location of the vehicle. In some implementations, a filter can be applied such that only particular vehicle repair stations are provided, for example, if the vehicle is a Mercedes-Benz, then only vehicle repair stations that repair Mercedes-Benz vehicles are provided. The locations of the vehicle repair stations can be displayed to the driver on the user interface display 103.

An engine or module, as the terms are used throughout this application, can be a piece of hardware that encapsulates a function, can be firmware or can be a software application. An engine or module can perform one or more functions, and one piece of hardware, firmware or software can perform the functions of more than one of the engines or modules described herein. Similarly, more than one piece of hardware, firmware and/or software can be used to perform the function of a single engine or module described herein.

The foregoing descriptions of specific embodiments of the present invention are presented for purposes of illustration and description. They are not intended to be exhaustive or to limit the invention to the precise forms disclosed. Rather, it should be appreciated that various modifications may be made without departing from the spirit and scope of the invention. Accordingly, other embodiments are within the scope of the following claims.

1. A method comprising:
obtaining a route or route segment based on a location of a vehicle and a destination;
based on the route, a current fuel supply of the vehicle, and a number of factors related to fuel consumption, estimating a refueling location;
determining a number of locations of fuel stations in proximity to the refueling location; and
presenting the number of locations of fuel stations to a user.

2. The method of claim 1, wherein presenting the number of locations of fuel stations comprises presenting a graphical display representing each of the locations on a map showing the route.

3. The method of claim 1, further comprising:
receiving traffic information relating to current traffic conditions affecting the route;
wherein estimating a refueling location includes determining additional fuel requirements due to traffic affecting the route.

4. The method of claim 1, further comprising:
filtering the fuel stations presented according to a predefined criteria.

5. The method of claim 4, wherein the predefined criteria comprises user-defined criteria selecting one or more fuel providers.

6. The method of claim 1, further comprising:
based on the route, a current time of day and a fuel efficiency of the vehicle, determining an approximate time of day the vehicle will reach the refueling location, and if the time of the day is within a defined proximity to a meal-time, then further presenting the locations of one or more restaurants within a defined distance to the one or more fuel stations.

7. The method of claim 6, wherein if the time of day is within a defined proximity to a meal-time, but there are less than a threshold number of restaurants within a defined distance to the refueling location, the method further comprising:
adjusting the refueling location to be closer to the current location of the vehicle and presenting the locations of one or more restaurants and fuel stations within a defined distance to the adjusted refueling location.

8. The method of claim 6, wherein if the time of day is within a defined proximity to a meal-time, but there are no restaurants satisfying a user-defined criteria located within a defined distance to the refueling location, the method further comprising:
adjusting the refueling location to be closer to the current location of the vehicle and presenting the locations of one or more restaurants satisfying the user-defined criteria and fuel stations within a defined distance to the adjusted refueling location.

9. The method of claim 1, wherein estimating a refueling location further comprises, based on the route and a fuel efficiency of the vehicle, determining when the fuel amount will be less than a user-defined threshold amount.

10. The method of claim 1, wherein the factors related to fuel consumption includes a fuel efficiency of the vehicle, the method further comprising:
receiving the fuel efficiency from a vehicle computing system included in the vehicle.

11. The method of claim 1, wherein the factors related to fuel consumption includes a fuel efficiency of the vehicle, the method further comprising:
calculating the fuel efficiency based on fuel amounts and odometer readings received from a vehicle computing system included in the vehicle.

12. A method comprising:
receiving at a navigation system present in a vehicle information from a vehicle computing system present in the vehicle, where the information relates to the vehicle requiring servicing;
determining a current location of the vehicle;
obtaining locations of one or more vehicle repair stations in a predefined proximity to the current location of the vehicle;
obtaining a map showing the current location of the vehicle and the locations of the one or more vehicle repair stations; and
providing a display of the map including indications of the current location of the vehicle and the locations of the one or more vehicle repair stations to a driver of the vehicle.

13. The method of claim 12, further comprising:
receiving a user-input setting to filter the vehicle repair stations indicated on the map based on a user-defined criteria; and
wherein providing the display of the map includes only locations of one or more vehicle repair stations satisfying the user-defined criteria.

14. A method comprising:
obtaining a route or route segment based on a location of a vehicle and a destination;
receiving a user request for locations of restaurants;
based on a current location of the vehicle and the route being traveled, determining a number of locations of restaurants that are in proximity to the current location and along the route; and
presenting the number of locations of restaurants to a user.

15. The method of claim 14, wherein presenting the number of locations of restaurants comprises presenting a graphical representation of the locations on a map showing the route.

16. A navigation system present in a vehicle for providing fuel-related navigation services comprising:
a positioning system configured to determine a current location of the vehicle;
a map application configured to provide a map including the current location and a user-defined destination;
a routing application configured to provide a route from the current location to the destination;
a fuel module configured to:
determine whether a current fuel amount in the vehicle is sufficient for the vehicle to travel the route, and if not, to determine a refueling location; and
obtain locations for one or more fuel stations within a defined proximity to the refueling location; and
a presentation engine configured to provide a display of the map including the route and locations of the one or more fuel stations indicated thereon.

17. A computer-readable medium having instructions stored thereon, which, when executed by a processor, cause the processor to perform operations comprising:
obtaining a route or route segment based on a location of a vehicle and a destination;
based on the route, a current fuel supply of the vehicle, and a number of factors related to fuel consumption, estimating a refueling location;
determining a number of locations of fuel stations in proximity to the refueling location; and
presenting the number of locations to a user.

18. The computer-readable medium of claim 17, wherein presenting the number of locations to a user comprises presenting a graphical representation of each location on a map showing the route.

19. The computer-readable medium of claim 17, further having instructions stored thereon which, when executed by a processor, cause the processor to perform operations further comprising:
receiving traffic information relating to current traffic conditions affecting the route;
wherein estimating a refueling location includes determining additional fuel requirements due to traffic affecting the route.

20. The computer-readable medium of claim 17, further having instructions stored thereon which, when executed by a processor, cause the processor to perform operations further comprising:
filtering the fuel stations presented to the user according to a predefined criteria.

21. The computer-readable medium of claim 20, wherein the predefined criteria comprises user-defined criteria selecting one or more fuel providers.

22. The computer-readable medium of claim 17, further having instructions stored thereon which, when executed by a processor, cause the processor to perform operations further comprising:
based on the route, a current time of day and a fuel efficiency of the vehicle, determining an approximate time of day the vehicle will reach the refueling location, and if the time of the day is within a defined proximity to a meal-time, then further presenting to the user locations of one or more restaurants within a defined distance to the one or more fuel stations.

23. The computer-readable medium of claim 22, wherein if the time of day is within a defined proximity to a meal-time, but there are less than a threshold number of restaurants within a defined distance to the refueling location, further having instructions stored thereon which, when executed by a processor, cause the processor to perform operations further comprising:
adjusting the refueling location to be closer to the current location of the vehicle and presenting to the user locations of one or more restaurants and fuel stations within a defined distance to the adjusted refueling location.

24. The computer-readable medium of claim 22, wherein if the time of day is within a defined proximity to a meal-time, but there are no restaurants satisfying a user-defined criteria located within a defined distance to the refueling location, further having instructions stored thereon which, when executed by a processor, cause the processor to perform operations further comprising:
adjusting the refueling location to be closer to the current location of the vehicle and presenting to the user locations of one or more restaurants satisfying the user-defined criteria and fuel stations within a defined distance to the adjusted refueling location.

25. The computer-readable medium of claim 17, wherein instructions to cause the processor to estimate a refueling location further comprise instructions to cause the processor to determine, based on the route and a fuel efficiency of the vehicle, when the fuel amount will be less than a user-defined threshold amount.

26. The computer-readable medium of claim 17, wherein the factors related to fuel consumption includes a fuel efficiency of the vehicle, further having instructions stored thereon which, when executed by a processor, cause the processor to perform operations further comprising:
receiving the fuel efficiency from a vehicle computing system included in the vehicle.

27. The computer-readable medium of claim 17, wherein the factors related to fuel consumption includes a fuel efficiency of the vehicle, further having instructions stored thereon which, when executed by a processor, cause the processor to perform operations further comprising:
calculating the fuel efficiency based on fuel amounts and odometer readings received from a vehicle computing system included in the vehicle.

28. A system comprising:
a processor;
a storage device coupled to the processor and configurable for storing instructions, which, when executed by the processor cause the processor to perform operations comprising:
obtaining a route or route segment based on a location of a vehicle and a destination;
based on the route, a current fuel supply of the vehicle, and a number of factors related to fuel consumption, estimating a refueling location;
determining a number of locations of fuel stations in proximity to the refueling location; and
presenting the locations of fuel stations to a user.

29. The system of claim 28, wherein presenting the number of locations to a user comprises presenting a graphical representation of each location on a map showing the route.

30. The system of claim 28, the instructions which, when executed by the processor cause the processor to perform operations further comprising:
receiving traffic information relating to current traffic conditions affecting the route;
wherein estimating a refueling location includes determining additional fuel requirements due to traffic affecting the route.

31. The system of claim 28, the instructions which, when executed by the processor cause the processor to perform operations further comprising:
filtering the fuel stations presented to the user according to a predefined criteria.

32. The system of claim 31, wherein the predefined criteria comprises user-defined criteria selecting one or more fuel providers.

33. The system of claim 28, the instructions which, when executed by the processor cause the processor to perform operations further comprising:
based on the route, a current time of day and a fuel efficiency of the vehicle, determining an approximate time of day the vehicle will reach the refueling location, and if the time of the day is within a defined proximity to a meal-time, then further presenting to the user locations of one or more restaurants within a defined distance to the one or more fuel stations.

34. The system of claim 33, wherein if the time of day is within a defined proximity to a meal-time but there are less than a threshold number of restaurants within a defined distance to the refueling location, the instructions which, when executed by the processor cause the processor to perform operations further comprising:
adjusting the refueling location to be closer to the current location of the vehicle and presenting to the user locations of one or more restaurants and fuel stations within a defined distance to the adjusted refueling location.

35. The system of claim 33, wherein if the time of day is within a defined proximity to a meal-time, but there are no restaurants satisfying a user-defined criteria located within a defined distance to the refueling location, the instructions which, when executed by the processor cause the processor to perform operations further comprising:
adjusting the refueling location to be closer to the current location of the vehicle and presenting to the user locations of one or more restaurants satisfying the user-defined criteria and fuel stations within a defined distance to the adjusted refueling location.

36. The system of claim 28, wherein instructions causing the processor to perform operations comprising estimating a refueling location further comprise instructions causing the processor to determine, based on the route and a fuel efficiency of the vehicle, when the fuel amount will be less than a user-defined threshold amount.

37. The system of claim 28, wherein the factors related to fuel consumption includes a fuel efficiency of the vehicle, the instructions which, when executed by the processor cause the processor to perform operations further comprising:
receiving the fuel efficiency from a vehicle computing system included in the vehicle.

38. The system of claim 28, wherein the factors related to fuel consumption includes a fuel efficiency of the vehicle, the instructions which, when executed by the processor cause the processor to perform operations further comprising:
calculating the fuel efficiency based on fuel amounts and odometer readings received from a vehicle computing system included in the vehicle.
